(19) United States
(12) Patent Application Publication
(10) Pub. No.: US 2010/0292921 A1
(43) Pub. Date: Nov. 18, 2010

(54) MODE OF TRANSPORT DETERMINATION

(76) Inventors: Andreas Zachariah, Surrey (GB); Nicholas Burch, Oxfordshire (GB)

Correspondence Address: KLEIN, O'NEILL & SINGH, LLP, 18200 VON KARMAN AVENUE, SUITE 725, IRVINE, CA, 92612, US

(21) Appl. No.: 12/664,215

(22) PCT Filed: Jun. 13, 2008
(86) PCT No.: PCT/GB2008/002026

§ 371 Date: May 17, 2010

(30) Foreign Application Priority Data
Jun. 13, 2007 (GB) 0711523.1

(51) Int. Cl. G01C 21/34

(52) U.S. Cl. 701/209

(57) ABSTRACT

A method of determining a mode of transport for a portion of a user's journey is described. The method comprises: receiving, at a portable device being carried by a user, position data for current locations of the user over a period of time; determining, from the position data, a characteristic of the speed for the journey portion; identifying possible modes of transport on the basis of pre-established ranges of speed characteristics for particular modes of transport; and selecting a most likely mode of transport from the identified possible modes of transport based on the proximity of the user's position data to known public transport nodes. The method can also be used to determine the carbon footprint of a user using a portable device.

### CROSS-REFERENCE TO RELATED APPLICATION(S)

This is a national phase application of PCT No. PCT/GB2008/002026, filed Jun. 13, 2008, which claims priority to GB application No. 0711523.1, filed Jun. 13, 2007, the contents of each of which are expressly incorporated herein by reference as if set forth in full.

### FIELD OF ART

The present invention relates to a method and system for determining a mode of transport. One example application of the present invention is to use the determined mode of transport to calculate the environmental impact of personal composite journeys made using various modes of transport in an effective and accurate manner using reduced computation resources.

### BACKGROUND

Due to the realisation that human activities are having a potentially adverse impact on the environment, it is a common desire to be able to monitor, understand, and quantify those activities in order to consequently mitigate their effects.

For example, the combustion engine, used in the overwhelming majority of cars outputs a significant amount of carbon dioxide (CO₂). The combustion process also gives rise to emission of substances including carbon monoxide (CO), complex hydrocarbons, nitrogen oxides (NO) and other particulate matter.

The amount of carbon dioxide that a vehicle is permitted to emit, within Europe at least, is subject to a voluntary agreement between car manufacturers and the European Union, and there is a target to cap this at 120 g of carbon dioxide emitted per kilometre traveled, for all new passenger cars by the year 2012. There is a real drive, at both a political level and in the heart of the typical consumer, to reduce as much as possible the detrimental effect of everyday activities on the environment.

Like cars, virtually all forms of mass transit (bus, train, aeroplane, ferry or hovercraft) contribute to environmental damage through emission of combustion by-products. However, some forms of mass transport will have less impact on the environment, by virtue of the greater number of passengers carried per mile rendering this form of transport more energy efficient, and so it may be preferable to make use of public transport rather than using a car.

A commonly-used way of quantifying the environmental impact of a user is to calculate their “carbon footprint”, expressed as tonnes of carbon dioxide or tonnes of carbon emitted, usually on a yearly basis.

The Internet offers many websites for calculating the impact an individual or household has on the environmental impact. One such website is a website run by the Worldwide Fund for Nature which can be found at http://footprint.wwf.org.uk.

Websites, like the one above, permit a user to assess the existing impact made by their daily routine: the foods they eat, the places to which they travel and the way in which they do so, the energy expenditure of the electrical appliances which they use, and even the goods they buy. This may be the first step in enabling a user to reduce their environmental impact or carbon footprint, since the user becomes more educated on the activities which add to their carbon footprint. Extensive research has shown the importance of accountability and success of creating feedback loops in order to improve education and to effect change.

However, using calculating tools like those offered on the Internet often requires broad assumptions to be made by the user, particularly about the way in which the user travels. These tools often require the user to know how many miles they travel on a train or bus every year, and it is too cumbersome a job for most users to be able to obtain and record such information. It would be impossible to record all of a user's journeys in order to build up a true and complete picture of that person's environmental impact, on the basis of the way they travel.

Due to the large numbers of ways in which a user can travel, there is no single solution that enables a user to log all of their movements. Partial systems are known which relate to monitoring use of a user's travel card (for example an Oyster™ card used in London, UK). These systems use information stored on a chip embedded in the card to communicate user ID information to a central server which monitors ticket gates and stores a record of the places and times when a user traveled through those ticket gates. There are a number of disadvantages with using this system to track a user's movements in that the user need not always scan their card when they exit a mode of transport, for example, at out-of-city train stations where there are no ticket gates, or when users get off a bus. As a result, the picture of the user's travel is often incomplete and not reliable. Furthermore, there are security implications regarding this information, which could act as a bar to people taking up such a service, thereby limiting the number of people who could benefit.

Furthermore, the environmental impact of a car journey will vary by the type of car, the speed at which it was driven during the journey, whether there were extended stationary periods, and other such factors, and the user may also not be able to accurately provide the data that the calculator requires to give a true reflection of the user's environmental impact.

It is desired to overcome at least some of the above-described problems and provide an improved method of determining an individual's carbon footprint.

### SUMMARY

The present invention is based on the realisation that an accurate carbon footprint of an individual can be calculated if an individual's mode of transport can be determined for a given journey and where the journey is a composite one, the different modes of transport that the user uses need to be determined. Also this personal movement can be experienced, and hence automatically recorded and analysed unobtrusively, by a portable device such as a mobile telecommunications device, for example which the individual carries during the journey.

Advantageously, this results in continuous monitoring of the users movements, to provide comprehensive results, as opposed to generating snap shot or single sample sets.

More specifically, a key technical feature which the present invention provides is a method and system for determining a user's current mode of transport using a portable device, such that this information may be stored and used for calculating the user's impact on the environment, i.e. their carbon footprint.

According to a first aspect of the invention there is provided a method of determining a mode of transport for a portion of a user's journey, the method comprising receiving, at a portable device being carried by a user, position data for current locations of the user over a period of time; determining, from the position data, a characteristic of the speed for the journey portion; identifying possible modes of transport on the basis of pre-established ranges of speed characteristics for particular modes of transport; and selecting a most likely mode of transport from the identified possible modes of transport based on the proximity of the user's position data to known public transport nodes.

In a preferred embodiment, the selecting step comprises querying a database of location data for known public transport nodes each having an associated proximity, identifying any public transport nodes which the user's position data is within the associated proximity of, and storing the identified nodes in a travel status log.

Typically, the known public transport nodes are categorised by type of public transport, and the associated proximity of each node depends on the category of public transport associated with that node.

In a preferred embodiment, the method further comprises identifying event-related data from the received position data, the determined characteristic of speed, and/or the identified public transport nodes; the event-related data comprising a transport difference characteristic which can be used to distinguish between different modes of transport; storing the event-related data: and using the event-related data to modify the most likely mode of transport as determined from the results of the selecting step.

Typically, the using step comprises using rules-based logic to eliminate certain possible modes of transport on the basis of the event-related data, wherein each logic rule defines a particular characteristic of one or more modes of transport.

Selectably, the event-related data may be selected from the group comprising: individual journey legs, durations of position data signal loss, rate of change in direction of travel, and stationary moments; and the using step may comprise using the event-related data during the selecting step in order to assist in the accurate determination of the user's mode of transport for a current journey leg.

Optionally, the event-related data may be selected from the group comprising: individual journey legs, durations of position data signal loss, rate of change in direction of travel, and stationary moments; and the using step may comprise using the event-related data to correct a previously determined mode of transport determined by the selecting step.

In a preferred embodiment, the method further comprises sensing an additional user device in the local vicinity of the user implementing the above-described method: communicating with the additional user device to determine the additional user device's current selected mode of transport: and correcting the user's selected mode of transport, if the position data for both the user and the additional user correlate with each other for a required time period, there is a difference between the selected modes of transport for the user and the additional user, and if the selected mode of transport established for the additional user, is deemed to be more reliable than the selected mode of transport for the user.

Preferably, the method further comprises receiving additional sensor data, and using the additional sensor data during the selecting step in order to enable more accurate determination of the user's mode of transport for a journey leg.

Optionally, the method further comprises receiving additional sensor data, and using the additional sensor data to correct a previously determined mode of transport determined by the selecting step.

The additional sensor data may be data provided by a device selected from one of the group comprising: a heart rate monitor, an accelerometer, wireless communication device, and a near field communications device.

In a preferred embodiment, the method further comprises identifying altitude and/or direction data, wherein the selecting step utilises the identified altitude and/or direction data.

Preferably, the using step comprises using rules-based logic to eliminate certain possible modes of transport on the basis of the additional sensor data or the direction/altitude data.

Typically, the receiving step comprises receiving location data derived from received satellite positioning data or received mobile telecommunication triangulation positioning data.

In a preferred embodiment, the method further comprises presenting the determined mode of transport for a portion of the user's journey, and enabling the user to input a different mode of transport to override the selection if the portion of the user's journey has been incorrectly determined.

Typically, the presenting step is implemented on a display and the enabling step is effected through a haptic interface.

In a preferred embodiment, the method further comprises receiving user input data, via a graphical user interface of the portable device, wherein the user input data comprises personal user locations frequently visited by the user; and using the personal user locations during the selecting step in order to enable more accurate determination of the user's mode of transport for a journey leg.

In a preferred embodiment, the method further comprises receiving user preference data, via the graphical user interface, the user preference data may detail features of a typical user journey; and using the user preference data during the selecting step in order to enable more accurate determination of the user's mode of transport for a journey leg.

Preferably, the method comprises specifying relationships between public transport nodes, the relationships being specified for nodes which are linked by a common mode of public transport having a route for that mode of transport connecting the nodes: and using the specified relationships during the selecting step in order to enable more accurate determination of the user's mode of transport for a journey leg.

In a preferred embodiment, the method further comprises predicting one or more likely next public transport nodes the user will be within the proximity of if the determined mode of transport is correct; checking that an actual next identified public transport node is one of the one or more expected public transport nodes in order to verify a determined mode of transport is correct: and correcting the determined mode of transport, if the next identified public transport node is not one of the one or more expected public transport nodes.

According to a second aspect of the invention there is provided, a method of determining a carbon footprint of a user, the method comprising a method of determining a mode of transport for a portion of a user's journey according to any preceding claim; calculating the environmental impact of each leg of the journey for each different type of mode of transport: and presenting the results of the calculating step to the user.

Preferably, the presenting step comprises presenting the results graphically on a screen of the portable device.

Typically, the presenting step comprises presenting the results in one of a plurality of different user-selected units, at least one of the plurality of different units being in a readily comprehendible unit of an everyday object, for example volume being expressed in pints or even the volume of a bus.

In a preferred embodiment the method further comprises finding an alternative route for a user journey which results in a lower overall environmental impact.

According to another aspect of the present invention, there is provided an apparatus for determining a mode of transport for a portion of a user's journey, the apparatus comprising: a portable device being carried by a user, the device incorporating receiving means for receiving position data for current locations of the user over a period of time: determining means determining from the position data, a characteristic of the speed for the journey portion; identifying means for identifying possible modes of transport on the basis of pre-established ranges of speed characteristics for particular modes of transport; and selecting means for selecting a most likely mode of transport from the identified possible modes of transport based on the proximity of the user's position data to known public transport nodes.

In a preferred embodiment, the determining means identifying means and selecting means are also provided within the portable device.

Typically, the apparatus comprises a mobile telecommunications device.

In a preferred embodiment, the method further comprises means for determining the environmental impact of the portion of the journey, and means for displaying the environmental impact to the user.

According to another aspect of the present invention there is provided a method of recording a user's air travel, the method comprising receiving, at a portable device being carried by a user, position data for current locations of the user over a period of time: identifying, from the position data, whether the user is in the vicinity of an airport; determining when a flight takes place; inferring a measure for the distance of that flight; and storing the determined distances of all of the flights the user takes in a travel status log.

In a preferred embodiment, the determining step comprises monitoring whether the portable device is switched off in the vicinity of a first airport, and is subsequently turned on in the vicinity of a second airport; calculating the speed at which the user traveled between the first and second airports; and confirming the user traveled via an aircraft when the calculated speed is only possible via an aircraft.

Preferably, the inferring step comprises calculating a direct distance value for the distance between the first and second airports or using a route specific distance value retrieved from an air travel route database, the route specific distance value being attributed to a realistic flight plan for specific routes.

It is to be appreciated that where references to airport are to be taken to mean a transport hub for aircraft.

A particularly useful application of the present invention is intended to assist the user in automatically determining a more accurate picture of the way in which the user travels, and as such, the user's impact on the environment, for example, as a consequence of that travel, without requiring the user to record their own movements.

The present inventors have appreciated that one way in which this can be achieved is for the user to carry the portable device as the user travels and to record the user's journey automatically. The inventors have also appreciated that since a vast number of the population make use of mobile technology, the device may advantageously be integrated within the user's mobile phone for example as a downloadable application running on the mobile phone. However, it is to be appreciated that this is not essential to the present invention and alternative devices may be suitable as described in further detail later.

In an embodiment of the present invention, the portable device, being transported (carried) by the user, is able to record the user's current position, in relation to their last position, and in this manner it is possible to monitor the journey (geographical movement) of a user as they travel over a period of time. It is also possible to provide feedback to the user in real-time as they travel along their journey.

Over a longer period of time, according to one embodiment of the present invention, a user can advantageously access and contextualise information regarding their journey's impact on the environment. Furthermore, a user may compare their statistics with those of the national average or against any other linked individuals or organisations, adding further weight and meaning to the information regarding their environmental impact.

As a user's movements are recorded, it is possible to determine information relating to their average speed over certain “legs” of the journey, this information can be categorised as corresponding to one or more different modes of transport. For example, anything over about 400 km/hour is very likely to be an aeroplane journey. And anything below about 8 km/hour is very likely to be a journey made by foot. Different modes of transport have different average speed ranges between these extremes.

Given a person's personal movement over each leg of a journey, it is possible to construct a log of the environmental impact of each leg, based on factors pertinent to the mode of transport determined as having been adopted for each leg. Typically, this involving multiplying the average speed for a given leg by a carbon consumption factor associated with the form of transport having used for that leg.

As will be appreciated, there are many ways of tracking an individual's movements. For example, there are methods based on mobile telecommunications technology, whereby the general location of a mobile telephone can be established by triangulation of the signal strength emitted from the mobile telephone's radio as received at multiple nearby communication cell radio masts. Advantageously, more than one type of geographical location system can be used such that if a signal from one system is unavailable, an alternative can be used.

One example of this type of positioning system is a peer-to-peer wireless positioning system that triangulates signals broadcasted from Wi-Fi access points and cellular towers to provide position data. A triangulation network is based on a collaborative database, where members who also have a Global Positioning System (GPS) provide position details of Wi-Fi nodes and cellular towers. Once the data they provide is synchronised, it is made available to all the other users of the network. An example of the above collaborative positioning system is provided by Navizon™.

Another method for tracking geographical movement is used Geospatial Information Systems (GIS), such as the Global Positioning System ('GPS') which relies on satellite signals. Other satellite systems can be used to the same effect, e.g. the European Gallileo positioning system and the Russian GLONASS system. In this embodiment, the device is capable of receiving the satellite transmissions and determining position data of the device's location, to within an accuracy of metres. The position data may be geographic co-ordinates or lines of latitude and longitude. The position data may also include a current altitude of the device.

Regardless of the format of the data, it is typically refreshed on a regular basis and as the user/device moves, a ‘picture’ or record of the user's travel may be generated. Monitoring the movement of the device in this manner also enables determination of a characteristic of the user's travelling speed, for example, average speed over a particular sampling period, maximum speed for that sampling period, or any other related characteristic of the user's speed. Reference to average speed herein is taken to include any such characteristic of the user's speed which is attributable to a particular journey portion or leg.

Other positioning systems may be suitable, using positioning technology including but not limited to: Enhanced Observed Time Difference (EOTD); Observed Time Difference of Arrival (OTDOA); Cell of Origin (CoO); Angle of Arrival (AoA); and Assisted-Global Positioning System (A-GPS).

The device may advantageously comprise a mobile telecommunication device and more preferably a mobile device having in-built GPS technology that can readily be used for the present invention.

However, there are constraints available in using mobile phone technology in that there are limitations regarding available processing power, memory size, and battery life, at least. Furthermore, in the embodiment which utilises GPS, satellite data may not always be available since devices picking up the satellite signal often have difficulty locking onto that signal. This is a particular problem when the user is within buildings, in tunnels, and especially underground. The picture/record of the user's journey may in such circumstances be incomplete, and this makes the determination of the current transport mode more complicated. The present invention has been designed to operate with these constraints, and to accommodate the limitation associated with portable devices for example, mobile telecommunications devices, and positioning systems.

As highlighted above, the average speed of travel is a good indication of the mode of transport of the user. However, a problem arises when the average speed calculated may apply to more than one mode of transport for a given time period. For example, using the average measured speed alone, it is impossible to differentiate between a tube, train and car travel, on the basis of average speed data alone. There is no known way of distinguishing between these three different transport modes in this situation.

This problem of a given average speed being attributable to multiple modes of transport is illustrated in the graph of FIG. 1, in which the horizontal axis represents speed, increasing to the right. The ranges of speed available for a given mode of transport are shown in ascending order. The average speed u₁ shown at the dotted line can apply to a tube, train or car. There is no way to distinguish between these three using just the value of u₁. It is to be appreciated that the speeds represented in FIG. 1 are average speeds for a vehicle over a period of time. Of course, all modes of transport start from zero miles per hour, and there is even more overlap at this range. The horizontal dashed lines show the actual speeds possible for a mode of transport, and the solid horizontal lines indicate typical average speeds possible for each mode.

However, the present inventors have appreciated that by considering the location of the user at the time(s) when that value u₁ was recorded, further information about the user's journey can be used to deduce the most likely mode of transport. This deduction may not be necessary if the speed recorded is uniquely assignable to a sole mode of transport, or if information regarding the speed of a user's journey makes it very likely that only one mode of transport is applicable.

The method and apparatus of the present invention utilises nodal data to create a framework of nodes for the region in which the user is travelling. The nodal data is a collection of locations (nodes) which are typically related to a given type of transport network and, more specifically, locations where user journeys are likely to interact. For example, nodal data may include locations of public transport hubs/nodes (PTNs) including without limitation bus stops, train stations, tram stations, metro stations, airport terminals, taxi ranks, road layouts, and ferry terminals. These public transport hubs/nodes are points of egress and entry for a user. As such, a user being located at one of these PTNs may be indicative of a user changing from one mode of transport to another. A significant advantage of providing data in such a form is that the data set required to store an ‘effective’ map of a territory becomes significantly reduced in size, for example 3 to 4 Mb as compared to 700 Mb for a conventional map, for example a map of the UK. Furthermore, an application for using the data set to determnine the mode of transport for the current leg of a journey and the associated carbon footprint contribution, can also be reduced in size as a consequence. Typically, the application can be only 400 Kb in size. To put this in perspective, this is for lower than an MPEG or most single MP3 music file. This reduction in size advantageously enables the data set and application to be provided on a conventional mobile telecommunications device without difficulty.

GPS operates by determining position information about the device's current geographical location, and this is used in relation to the user's previous location to provide information about the speed at which the user is moving. GPS may also provide the device's current altitude and bearing/direction information. A GPS chip or device is able to output these results for use in the present invention. Other positioning systems may enable calculation of position, speed, bearing/direction and/or altitude data.

From the position information of the user, the apparatus can determine additional information about the location of the user. The additional information may include details of the road network, public transport hubs/routes in the vicinity, and so can be used to infer the user's mode of transport. If there is, for example, no road network in the vicinity, it is likely that the user was running, walking or cycling depending on speed. If there is a bus stop, it is likely that the user was taking a bus. If there is a portion of the road network, but no bus stops nearby, it is likely that the user was in a car.

### BRIEF DESCRIPTION OF THE DRAWINGS

For a better understanding of the present invention and in order to show how the same may be carried into effect reference will now be made, by way of example, to the accompanying drawings in which:

FIG. 1 is a chart showing the relative speeds of different modes of transport;

FIG. 2 is a schematic system diagram of the components relating to an embodiment of the present invention;

FIG. 3 is a flow diagram illustrating a method of mode of transport determination according to an embodiment of the present invention;

FIG. 4 is graphical representation of an example journey showing how speed varies over time:

FIG. 5 is a functional block diagram illustrating a device, including a transport mode determining module, according to an embodiment of the present invention;

FIGS. 6A and 6B are flow diagrams providing more detail of different parts of the method illustrated in FIG. 2;

FIG. 7 is an example database of node data for use by a transport mode determining module of FIG. 4:

FIGS. 8A and 8B are schematic examples of screenshots of a Graphical User Interface of an embodiment of the invention showing result data; and

FIG. 9 is an example image of a user's journey route showing different modes of transport.

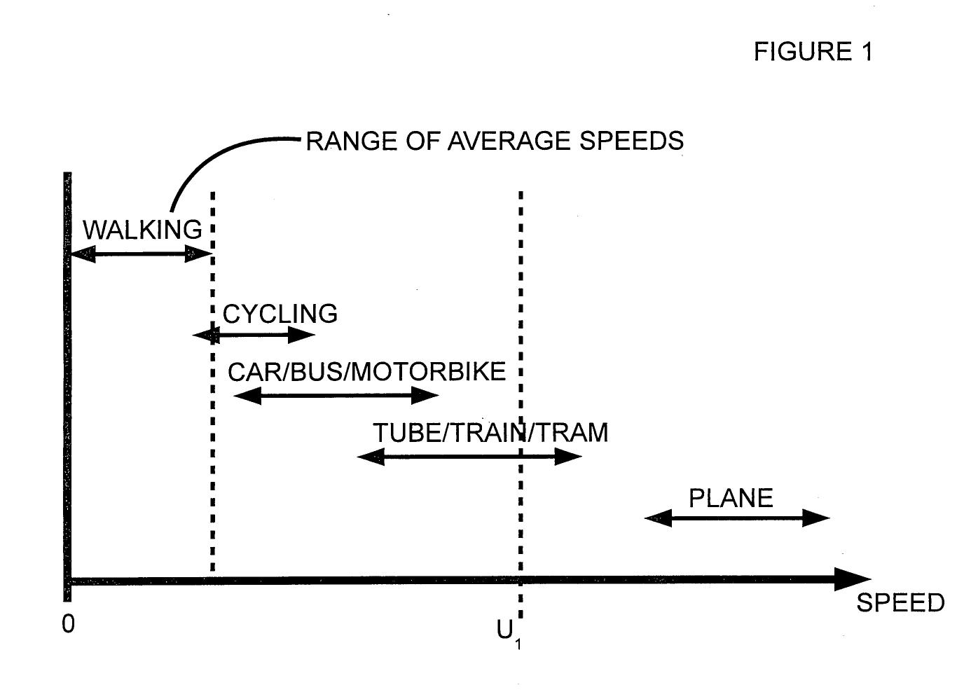

### DETAILED DESCRIPTION

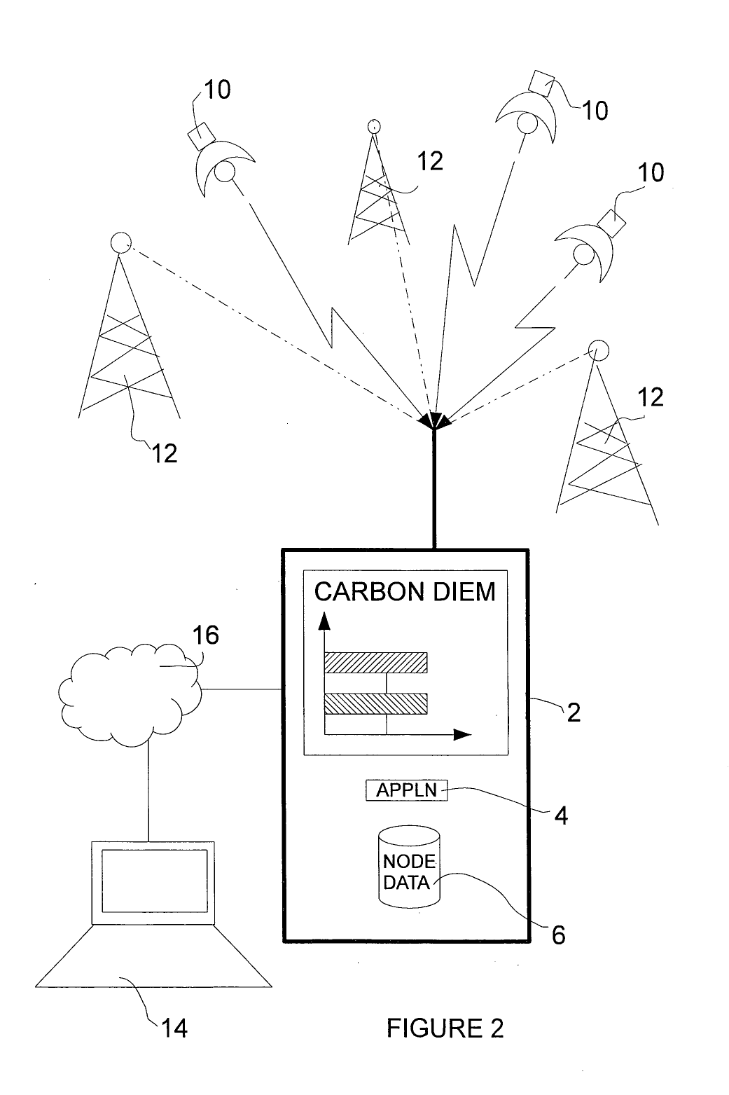

Referring now to FIG. 2, an embodiment of a system according to the present invention is shown. As can be seen, the present embodiment is implemented on a mobile phone 2, as an application which when run, configures the mobile phone 2 to operate a method in accordance with the present embodiment, described in more detail below. However, as can be seen from FIG. 2, the essential components of the embodiment are an application 4 and a node data database 6 stored on a mobile telecommunications device 2. Node data has been described earlier in this application. The application may be provided to the device in different ways for example it may be downloadable from a central server (over the air or by use of a personal computer), may be installed during manufacturing, or may be present on a memory device for use with the mobile phone.

The device has the ability to interact with a positioning system 10, such as GPS, to determine the current geographical location of the mobile phone. This basic location information and a clock on board the mobile phone are use to determine speed of geographical movement.

FIG. 2 also shows an alternative system which is based on a WiFi cell network 12 to determine the geographic location of the device.

FIG. 2 also shows a further alternative system in which the device 2 communicates with an external processing computer 14, which may be a personal computer or a central server. Communication being effected via any suitable communication channel 16 i.e. any mobile telecommunication channel, Internet, WiFi, Bluetooth or a physical wired connection.

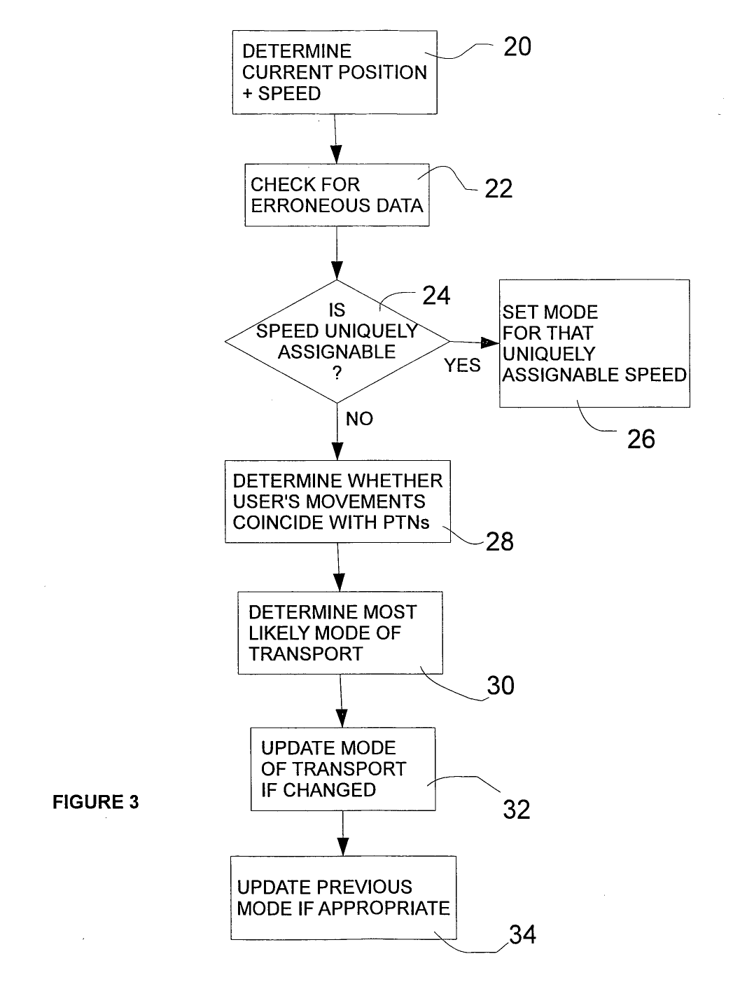

The flow diagram of FIG. 3 illustrates an embodiment of the method of the present invention, which is implemented on the mobile phone of FIG. 2.

Using a geographical location determining system, for example GPS (Global Positioning System), the device determines, at Step 20, current user position (geographic location) and speed data on a continuous basis. The received data is checked, at Step 22, for nonsensical, erroneous results, and also to test for certain conditions, for example, if the user is for the most part considered to be stationary, or if there has been a loss of signal since the last time position and speed data was determined. Gathering this additional information is useful for determining more accurately the user's geographical movements.

The device also determines, at Step 24, if the current mode of transport is attributable to a unique mode of transport, and if so sets, at Step 26, the mode appropriately. For example, if the speed measured is only possible when a user is on a train, then the current mode of transport, for a current leg of a journey, is set as being a train.

If the user's speed is not uniquely assignable in the manner described above, the device assesses, at Step 28, whether the user's pattern of geographical movement coincides with any public transport hubs or PTNs (Public Transport Nodes) that may indicate if the user is utilising public transport.

The device determines, at Step 30, the most likely mode of transport given the user's speed, position data, historical record/pattern of movement, and PTN node data in combination with a set of logic rules (described later) which estimate the most likely mode of transport for a plurality of different scenarios. The set of logic rules operate in a heuristic manner to provide an educated guess as to the most likely mode of transport being used. It is also to be appreciated that other data may be used to assist in the determination of the mode of transport to give a more accurate best guess estimate, Some examples of the additional data which may be used is described in more detail later.

After a best guess estimate has been determined regarding the mode of transport, the device updates, at Step 32, the mode of transport with the estimate. The device is also capable of altering previous best guess estimates on the basis of new data and as such is capable of overwriting, at Step 34, previous best guess estimates with more accurate estimates, if appropriate.

During any one journey a user may make use of many different modes of transport: each mode of transport being referred to as a different journey leg. As such, it is important to be able to distinguish when a user changes between different modes of transport. This information is also required when monitoring the distance traveled using certain modes of transport, such that the environmental impact of those journeys can be quantified and used to determine the user's carbon footprints for example.

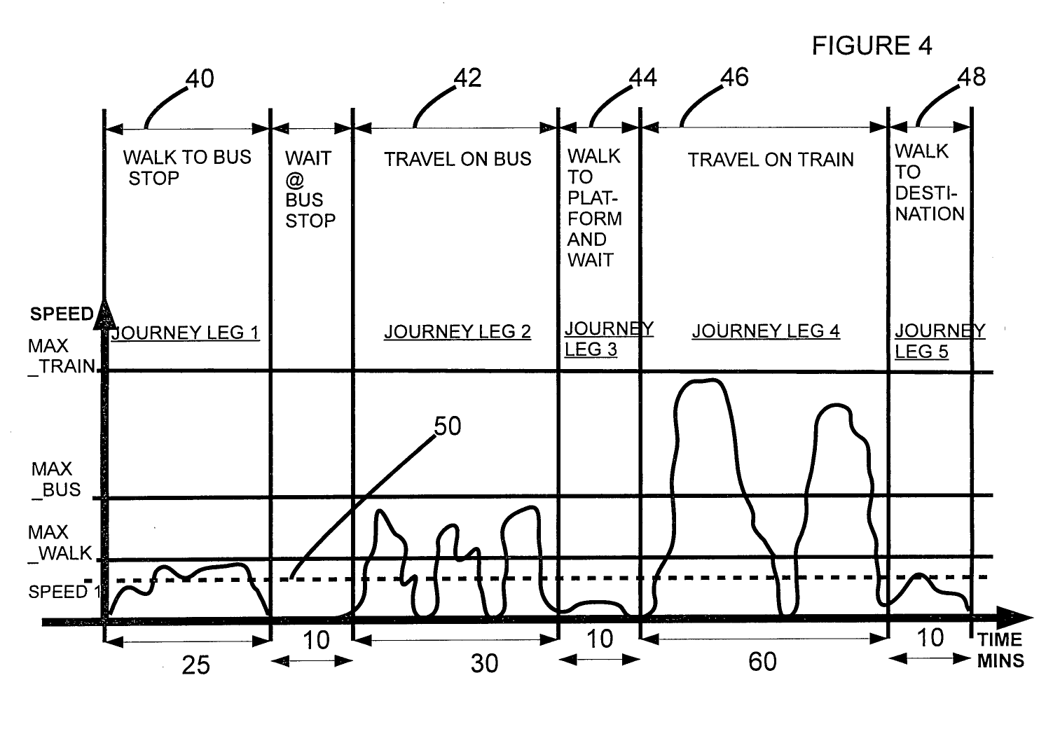

An example journey is shown in FIG. 4 and includes: a user walking from home to a bus stop, in a first journey leg 40: getting a bus to a train station, in a second journey leg 42; walking to a train platform, in a third journey leg 44; and travelling on a train, in a fourth journey leg 46. The user gets off the train and walks to their destination in a fifth journey leg 48.

FIG. 4 further illustrates the problem that certain speeds, for example Speed 1 marked by the dashed line 50, may be applicable to multiple modes of transport.

Monitoring the speed of the user is one indication of which mode of transport is being used, and a change in speed is often indicative of the user changing to a different mode of transport. However, as will be appreciated, when walking, cycling, travelling by car, bus or train, the user's speed will often change and there may be many different stops for example at traffic lights or at bus stops, or at train stations. As a result, the task of identifying journey legs, and as such the mode of transport, is much more complicated. However, as described in more detail later, certain conditions can be inferred from the user's speed and location data in combination with the node data in order to deduce the most likely mode of transport. For this purpose, the device keeps a historical record of key information in order to be able to best detect when the user changes between different modes of transport, to determine the distance the user travels using each mode of transport and also to cross-check if a previous determination regarding a mode of transport for a given leg was correct.

In this way, the device's assessment may be continually reviewed based on previous or future determinations. Significant changes in average speeds of adjacent journey legs may indicate an alternative mode of transport. For example, a long pause in the vicinity of a train station, followed by a speed attributable to a train or a car, followed by a speed uniquely attributable to a train is more likely to be interpreted as a user waiting for a train, catching that train, the train moving slowly through an urban area, then speeding up when it reaches non-urban areas where the train speed is typically higher.

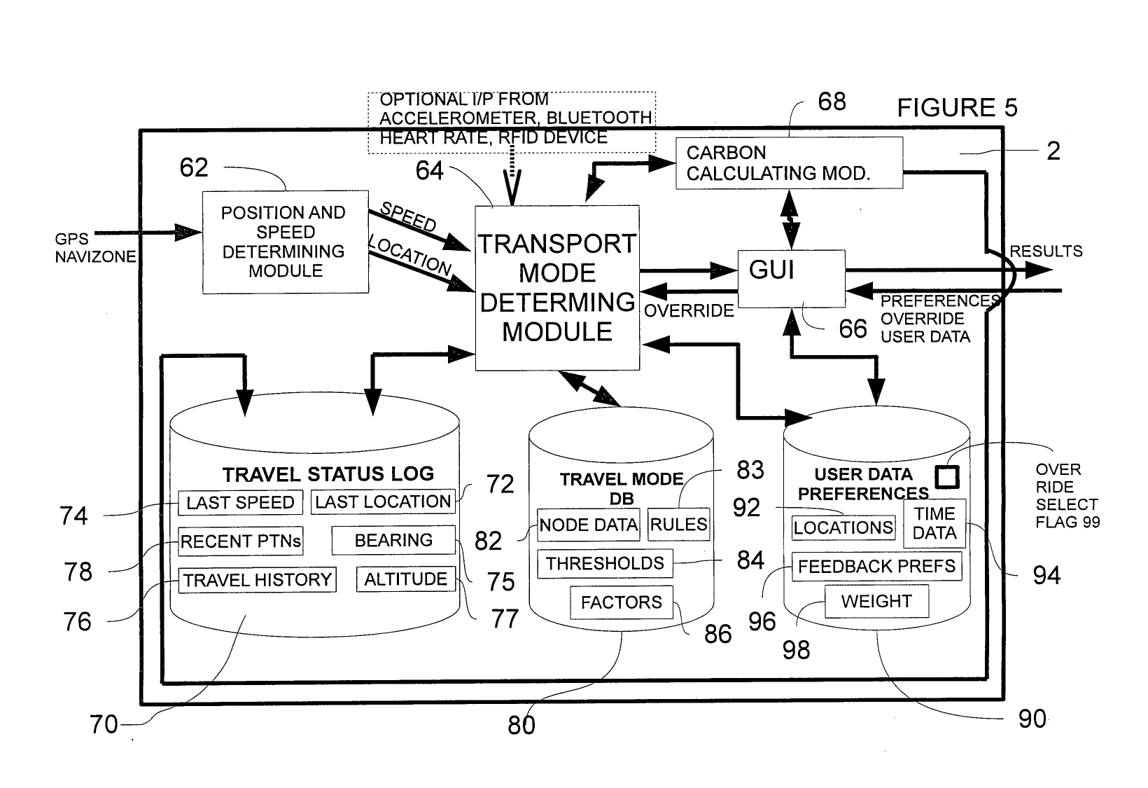

A functional block diagram of components of the portable device 2 of FIG. 2 according to the current embodiment of the present invention, is shown in FIG. 5.

As shown in FIG. 5, the device 2 comprises: a position and speed determining module (PSDM) 62, for determining at regular intervals a current position and current speed; and a transport mode determining module (TMDM) 64, for processing the determined position and speed information in relation to node data and historical data in order to determine the most likely mode of transport for a given journey leg. The device 2 also comprises a graphical user interface (GUI) 66, for enabling communication of results, which may include position and speed information, and/or carbon footprint results, time spent travelling and distance covered, to the user, and also for enabling user input data and preference data to be received. Furthermore, the device 2 comprises a carbon calculation module 68, which takes the results of the determined modes of transport for different journey legs and calculates the carbon footprint of the user.

Within the device 2 there are a plurality of memory stores including: a travel status log 70 for recording last location 72, last speed 74, and a travel history 76 for the user including CO₂ calculation results for each journey leg. The travel status log 70 also comprises a direction/bearing store 75, and an altitude store 77. The travel status log 70 also comprises a list 78 of recent PTNs that the user has recently passed. The device 2 also comprises a travel mode database 80 containing node data 82 relating to the location and type of PTNs, and any other additional map/node related data, a rules database 83, defining logic-based rules; a threshold speed database 84, for each mode of transport; and a travel mode factor database 86 used for the CO₂ calculations. A user preference database 90 is provided which stores user input data relating to (i) known user locations 92 (i.e. home, office etc), (ii) time/day data 94, (iii) feedback preference data 96; and (iv) a user's weight 98, for calculation of calorific expenditure during walking, running or cycling. The user preference database may further comprise details regarding the user's vehicle makes and models. An override select flag 99 may also be stored in the user preference database 90.

The PSDM 62 receives regular signals from the geographical location system. In the present embodiment of the invention, the geographical location system is GPS. However, the present embodiment need not be limited by this and other geographical location or positioning systems may be used.

The PSDM 62 uses the received signals to determine a current position for the device 2 and as such determines a current speed of the device 2. GPS devices are well known, and as such will not be discussed in detail herein for the purposes of describing the present embodiments.

The TMDM 64 uses the received speed and location information together with data from the travel status log 70, and the travel mode database to deduce the most likely mode of transport for the current journey leg.

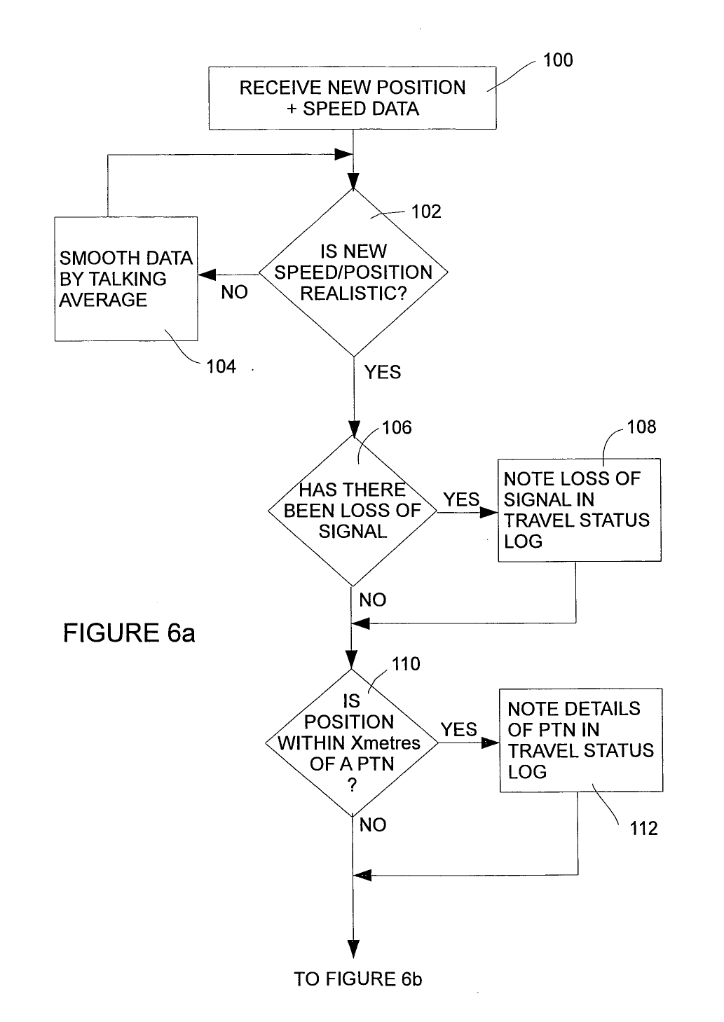

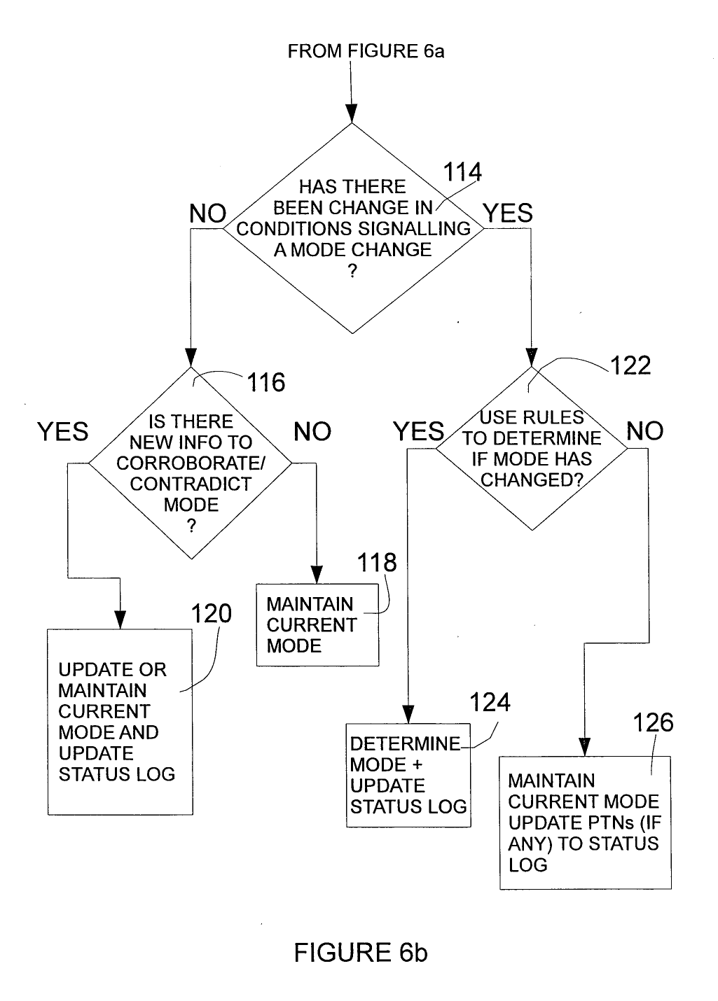

FIG. 6 shows an overview of the method steps that the TMDM 64 takes when determining the current mode of transport.

At regular intervals, for example every second, the TMDM 64 receives, at Step 100, anew position and a new speed for the device 2. The TMDM 64 then determines, at Step 102, whether the new speed/position is realistic, as explained below.

GPS signals may be erroneous due to an effect called jitter. For example, position data may establish the device 2 is at a first position at time t₀. One second later, the position data may establish the device 2 is one metre away, and every second thereafter the device 2 may determine the position is one metre away, indicating that the user is travelling at one metre per second. However, because of the jitter effect, the position data may determine that a subsequent position is an implausible distance away, indicating that the device 2 has moved at an unrealistic speed. There are physical restrictions to how fast the device 2 can move: for example, it is not possible for the device 2 to move faster than the speed of sound. In addition, it is not possible for the user to be travelling at the speed of a car, and then at the speed of an aeroplane, and then at the speed of a car again, in a short space of time without any stoppages. The device 2 compensates, at Step 104, for any erroneous data.

One method of compensating for erroneous data is to take an average speed of travel over a sample window, for example of 30 seconds. If an erroneous signal giving an unfeasible speed is received, that erroneous signal may be substituted by the average value of the speed. In this way, any errors in the data received are smoothed out.

The TMDM 64 identifies when the user's mode of transport changes, on the basis of the received data. Additional information may be gathered from the received data which is indicative of certain conditions, and which can give further insight into whether the user has or is about to change to a different mode of transport. This additional information relates to the time since the last position and speed data was received.

The TMDM 64 determines, at Step 106, whether the time since the last data is longer than a set period of T seconds. In one embodiment, T may be 20 seconds. The TMDM 64 may legitimately deduce that there has been a loss in satellite signal if there is a greater than T seconds gap between receiving data. This gap in data may be indicative of the user passing through a tunnel, or being underground. Noting a gap in receiving data, at Step 108, may be used to further corroborate transport mode determination, as described later.

The TMDM 64 next determines, at Step 110, whether there are any PTNs within a distance of X metres of the current position, which may indicate if the user has changed or is about to change to a different mode of transport.

The value of X varies depending on the mode of transport of the PTN. Table 1 below shows example values for X for corresponding modes of transport.

TABLE 1
Values for X

| PTN | Value of X |
|---|---|
| Bus stop | 25 m |
| Tube station | 75 m |
| Train station | 75 m |
| Airport | 10 km |

In one embodiment, the distance X simply represents a radius from a point representing a PTN. However, it is to be appreciated that this need not always be the case, and instead of defining a radius X, it may be possible within the node data of the travel mode database to specify the area to which the PTN is deemed to relate. For example, coverage of bus stops and train stations may be defined as ellipses, relating to the position of a bus stop on a road, and also the train platform within a station. This is advantageously imparts a directional nature to the PTN indicating valid directions of travel from the PTN for a given type of transport. In addition, coverage of a tube station may be defined as an area encompassing all of the tube and train station entrances and exits. In London, for example, there are some stations (e.g. Victoria and Waterloo) that are both train and tube stations. The present inventors have appreciated this and because the determination of the mode of transport is checked when new additional information is received, as described below.

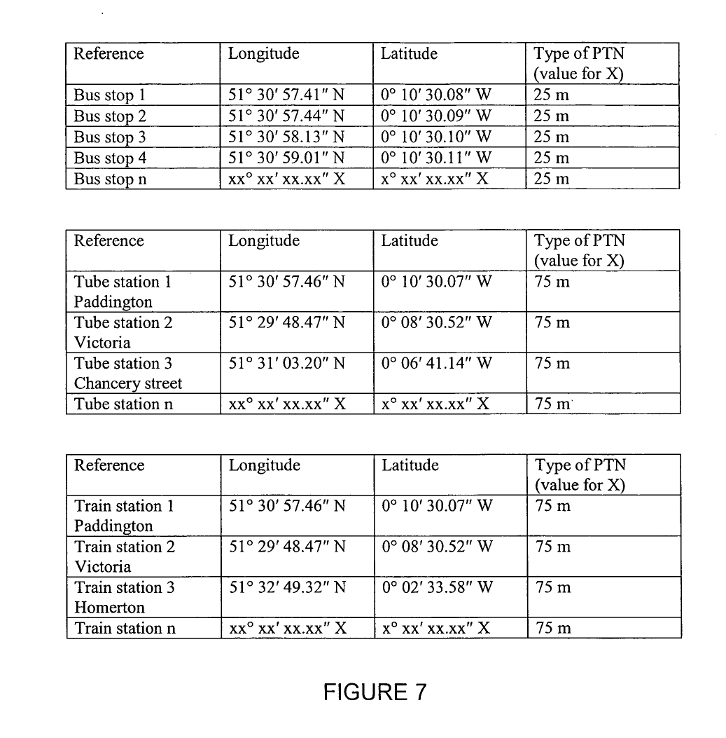

There are several different ways in which the TMDM 64 can determine whether the user's current position is within X metres of a PTN. One method includes maintaining a database of geographic co-ordinates of all PTNs, as shown in FIG. 7, including a value for X relating to the type or category of PTN.

The TMDM 64 may first identify the vicinity in which the user is present and cross check the users location for bus stops within 25 m, tube or train stations within 75 m, and airports within 10 km.

If it is determined, at Step 110, that the user is within an appropriate distance of a PTN, the TMDM 64 updates, at Step 112, the travel status log 70 with this information.

The TMDM 64 also identifies, at Step 114, if there has been any change in travel conditions that may indicate that the user has changed to a different mode of transport. Typically, such a change will involve the user being stationary for a period of time, or will involve a significant change in speed or average speed.

If the TMDM 64 identifies at Step 114 that there is no change in travel conditions indicative of a change of mode, the TMDM 64 determines, at Step 116, if there is any new information to corroborate or contradict the previously determined transport mode. If there is no new information, the TMDM 64 maintains, at Step 118, the current mode of transport as the previous mode of transport.

If the answer is yes, and if the new information corroborates the current mode, the TMDM 64 maintains, at Step 120, the current mode as the previous mode of transport, and adds the additional information to the travel status log 70. However, if the new information contradicts the current mode, but is deemed to be reliable, the TMDM 64 is arranged to update, at Step 120, the current mode to the newly determined mode of transport, and also adds the additional information to the travel status log 70.

An example of the additional information corroborating a previously determined mode may be where the TMDM 64 determines the mode is a bus because the journey leg starts at a PTN for a bus stop. If the next PTN is also a bus stop, and on the condition that the speed is appropriate for a bus, the determination that the mode is bus, for that journey leg, is substantiated.

An example of the opposite case, where the additional information contradicts the previously determined mode may be where the TMDM 64 determines the mode is a train because the last PTN was a train station, and the average speed conforms with that of a train, the mode may be determined to be a train. However, if the next PTN is a tube station, and the next station is also a tube station, the TMDM 64 is able to change the mode to tube for the complete journey leg. The TMDM 64 may also look at whether there has been a loss of signal, indicative of underground (subway) travel, in order to further corroborate the chain of events which could be applicable for tube or train travel.

When there has been a signal loss, the device will first ascertain it the user is moving, and if so will check whether the user was also moving prior to the signal loss. If the answer is yes, and the speed is consistent, the device will assume the mode of transport has not changed, until such a time as other contradictory information becomes available. This routine is also true for loss of signal when the user is travelling using other modes of transport.

If is determined that a change in travel conditions (i.e. change in average speed) has occurred, in Step 114, the TMDM 64 identifies, at Step 122, whether the change in travel conditions is indicative of a change in transport mode. Often this may be related to whether the user has been stationary. However, it does not necessarily follow that the user being stationary equates to a change in type of transport since there are a large number of valid reasons why a user may be stationary, including being stopped at traffic lights, at a bus stop, or at a train station, or that the user is stuck in slow-moving traffic. Alternatively, the user may have arrived at their destination, in which case the stationary moment (period of time) may also be followed by a loss of signal as the user enters a building and satellite positioning is no longer reliable.

The events that happen either side of a stationary moment (sequentially preceding and following that moment) are often indicative of why the user was stationary. In particular, it is possible to cross-check the user's stationary position against PTNs in the node data, and if they match (i.e. if the user's stationary position is within the radius X of the PTN) then it may be deduced that the user is waiting for that particular mode of transport. If that stationary/waiting time is followed by the user moving at a speed associated with that mode of transport, the deduct on that the mode must be that attributable to that speed is corroborated.

Furthermore, the length of a stationary moment may be indicative of the reason for the stationary moment. For example, the average time that a bus or train stops to let passengers on and off for is approximately 20 seconds. Stationary moments of this approximate length may be indicative of a user stopping at a PTN and moving off again on the same mode of transport, as opposed to changing to a different mode of transport

The present embodiment relies on rules-based logic to define characteristics in the received position and speed data and historical data set that are indicative of the current mode of transport. These characteristics enable the mode of transport to be narrowed down from the available modes, for a given speed, until a most likely mode can be deduced.

Table 2 below lists some example scenarios and the modes of transport that may result in those scenarios. The letter ‘Y’ stands for YES and denotes a mode of transport that could result in the scenario described, for example a current speed falling within threshold limits for a walking pace or slow cycle speed is possible for all modes of transport except air travel, which is denoted by the letter ‘N’ standing for NO.

TABLE 2
Example scenarios

| | | MODE | | | | | |
|---|---|---|---|---|---|---|---|
| | | | | Car/ | | | |
| Scenario | | Walk/cycle | Bus | bike | Tube | Train | Air |
| 1 | Current speed (CS) = walk/ | Y | Y | Y | Y | Y | N |
| | slow cycle | | | | | | |
| 2 | Average speed (AS) never | Y | N | N | N | N | N |
| | increases above max walking | | | | | | |
| | threshold (maxWT) for period | | | | | | |
| | TEST | | | | | | |
| 3 | AS does exceed maxWT and | N | N | Y | N | N | N |
| | not near a PTN at start of | | | | | | |
| | journey | | | | | | |
| 4 | AS does exceed maxWT but | N | Y | N | N | N | N |
| | does not exceed max train | | | | | | |
| | threshold (maxTT) and with | | | | | | |
| | bus PTNs at start and end of | | | | | | |
| | period test | | | | | | |
| 5 | MaxWT <AS> min train | N | Y | Y | N | N | N |
| | threshold | | | | | | |
| 6 | MaxWT <AS> min train | N | N | Y | N | N | N |
| | threshold AND start of leg is | | | | | | |
| | not near PTN | | | | | | |
| 7 | MaxWT <AS> min train | N | Y | N | N | N | N |
| | threshold AND start of leg is | | | | | | |
| | near PTN | | | | | | |
| 8 | Since last PTN direction has | Y | Y | Y | N | N | N |
| | changed by more than 90° | | | | | | |
| | within any 50 metre portion of | | | | | | |
| | journey | | | | | | |
| 9 | Last PTN = airport, then signal | N | N | N | N | N | Y |
| | loss, then current PTN = | | | | | | |
| | airport | | | | | | |

Air travel is in itself an exception to general rules relating to speed, since in one embodiment of the present invention, air travel is identified when a user is within a specified radius from an airport, following a signal loss, and where the previous position prior to the signal loss was also within a specified radius of an airport. This can be seen from entry 9 in Table 2 above. The reason for this scenario is because currently commercial airlines require passengers to turn off their mobile phones during the flight. Typically, users vary the time at which they turn their mobile off, between some point on their approach to the airport, to when the user is on the airplane awaiting departure. This is the reason the value for X, in table 1 above, is currently set at 10 kilometres.

It is to be appreciated that, as the requirement to turn mobile phones off will change in the near future, an average speed in the region of 200 to 600 mph would indicate air travel. In this eventuality the value for X may be changed to capture a truer picture of when a user is at an airport. Alternatively, if the GPS receiver in the mobile phone is also capable of determining an altitude of the device 2 from the received satellite signal, this may also be used to indicated air travel. Another option would be to measure the acceleration of the device 2 when in the vicinity of an airport (either using an accelerometer or by monitoring the rate of change of speed of the device 2). The logic based rules may easily be updated to cater for this change and may use a combination of the expected events (i.e. proximity to airport, altitude, and acceleration) to determine whether the mode of transport is air travel.

In the event of signal loss, a further check to corroborate the user has taken a flight, includes checking the distance between the position of the device 2 before signal loss, and the position of the device 2 after the signal loss, and to check the time it took for the journey. If this distance at the speed noted is only feasible by flying, then the mode of travel is set to be via an aeroplane.

Initialisation of the PSDM (GPS receiver) after the device 2 has been switched off includes a check routine to ascertain if the current location is an airport, and if the last known location is also an airport. If the answer to these queries is no, the device 2 will proceed to determine a mode of transport as normal. If the answer is yes, the device 2 will calculate the distance traveled by airplane and will update the travel status log 70 accordingly.

The list of scenarios in Table 2 is not exhaustive but serves to illustrate the type of queries which may be factored into the rules-based logic in order to deduce the most likely mode of transport.

A set of logic rules is created on the basis of these scenarios, in the form of IF, THEN, ELSE type statements. Examples of suitable logic rules are shown below. Again, this list is not exhaustive but illustrates the type of statements and rules that may be suitable. It is also to be appreciated that the number and complexity of the rules has a bearing on the accuracy of the determination of the mode of transport, since more rules mean more criteria must be satisfied to lead to a positive determination. As such, the scenario being tested for is more comprehensive. The present invention is not limited by the number or form of the rules.

A first example rule below relates the received speed with the modes of transport suitable for that speed. In this example, the received speed is the current received speed. However, in other examples the speed used may be the average speed (AS) measured over a sampling window, for example, 30 seconds.

FOR the received new speed:

mode={list of all modes possible for that speed}

IF the received speed is uniquely attributable to only one mode (i.e. instantaneous speed=400 km/h only possible by an aeroplane) then the current mode must equal the mode solely attributable to that speed:
ELSE IF the received speed averaged over a period of time (i.e. journey leg) is highly likely to be attributable to a sole mode of transport (i.e. if the average speed is never higher than the maximum walking speed then most likely the user is walking.

In a second example below, the TMDM 64 is attempting to ascertain if the direction the user is travelling in has changed by more that 90 degrees over a short period of time (i.e. within any 50 metre stretch of the journey). It is not possible for a train to move in this manner because of its large turning circle and, if the direction has changed by more than this amount, the mode cannot be a train. This rule removes that mode as a possibility. This is shown in Table 2, scenario 8.

Bearing/direction data may be available from the GPS device but is in any event readily attainable from the historical data regarding the user's current position relative to the previous geographical position, and this bearing data can be stored in the travel status log 70 at appropriate intervals.

IF a direction change since last PTN of greater that 90 degrees has been noted

THEN mode!=train

Other, self-explanatory, rules are shown as follows:

IF start of leg is not within distance X of any PTN

AND if speed between 10 mph and 70 mph

THEN mode=car

IF speed could be attributed to a bus

AND last PTN was bus stop

THEN mode=bus

IF speed could be attributed to a bike, bus or car

AND IF last three stops=bus stops

THEN mode=bus

Returning to FIG. 6, if it is determined at Step 122 that the mode of transport, has changed, the TMDM 64 proceeds to determine, at Step 124, the mode of transport using the rules-based logic. The mode of transport is updated, and the status log 70 is updated to include details regarding the start of the current journey leg, current mode (as determined) and a new PTN, if appropriate.

Otherwise, it is determined that the mode of transport has not changed, rather the change in conditions noted at Step 114 was due to some other reason, for example stopping at a set of traffic lights or at a bus stop. In this case, the TMDM 64 maintains, at Step 126, the current mode as it was and updates the status log 70 to include a new PTN, if appropriate.

As described earlier, determining the mode of transport enables the carbon calculating module 68 to calculate the environmental impact of individual legs of journeys. The carbon calculating module 68 retrieves an appropriate CO₂ multiplying factor from the travel mode factor database, on the basis of the determined mode of transport for that journey leg and the distance traveled during that journey leg.

Example CO₂ multiplying factors are shown below:

| Mode | CO₂ multiplying factor |
|---|---|
| Car (generic - medium) | 0.27 kgCO2 Per Km |
| Train (national) | 0.0443 kgCO2 Per Passenger Km |
| Tube | 0.053 kgCO2 Per Passenger Km |
| Bus (generic) | 0.0772 kgCO2 Per Passenger Km |

Where the example figures above refer to per passenger, the factor takes into account a nominal number of passengers for that mode of transport. In an alternative embodiment described below, multiple users in the same vicinity with devices operating with this service, a more accurate number of passengers may be determined and used to generate more accurate results.

It is to be appreciated the CO₂ multiplying factor database will comprise a large number of different CO₂ multiplying factors (also known as load factors) for specific modes of transport, and particularly may vary depending on the type of car the user drives which may be input into the user preference database for this purpose.

As shown in FIG. 5, the device 2 also comprises a graphical user interface to enable communication to and from the user. The GUI is capable of taking the calculated carbon results and formatting them to provide useful feedback to the user. The user is able to select preferences regarding the format of the data, and this serves to improve the intelligibility of the information by putting it into context with quantities that a user can readily identify with.

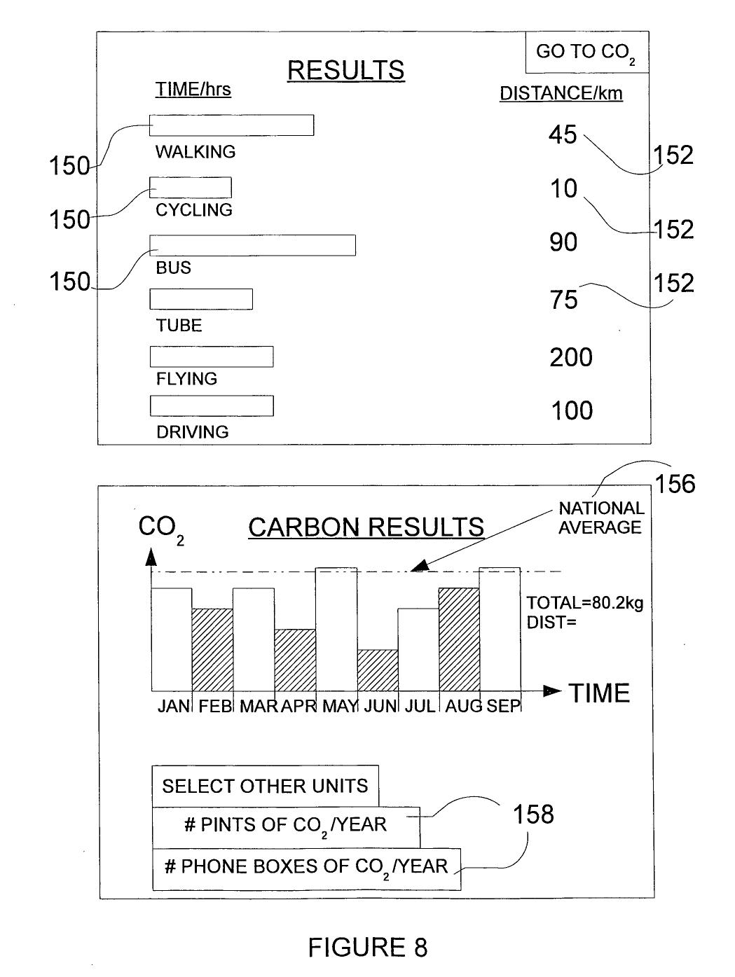

A graphical representation of example results is shown in FIGS. 8A and 8B. FIG. 8A shows, in real-time, running totals 150, 152 for time spent travelling, and distance traveled, respectively, using each of the different modes, and FIG. 8B shows a graphical representation of the total carbon footprint as a result the user's travel, broken down on a month by month basis. This graphical representation is shown in relation to a national average 156.

The graphical representation may also be made with reference to other averages or with respect to other linked individuals, for example, a groups of users who work together. The information regarding the national average or group averages may be downloaded to the device, if appropriate, or may be reviewed when processed by or uploaded to a central server.

Also, shown in FIG. 8B are options for the user to select to see the carbon results using different measurement units 158, for example, number of pints, number of phone boxes to name just a few. The purpose of these different measurement volumes is that it enables the user to visualise better the actual quantity of carbon generated as a result of the user's actions, a opposed to a value of weight (e.g. kilograms or tonnes) which is inherently harder for a user to comprehend in real terms.

For example, the volume of 1 g of CO₂ is almost roughly equivalent to a pint in volume (1 g=0.56 litres, a pint=0.545 litres, and a litre of CO₂=1.98 g). Other examples quantities include:
the volume of a UK standard phone box is approximately equivalent to 500 g of CO₂;
the volume of a UK standard letter box is approximately equivalent to 250 g of CO₂; and
the volume of a Route Master double-decker bus is approximately equivalent to 1 tonne of CO₂

Any suitable units and visual indicators may be used to provide feedback to the user regarding their carbon footprint.

In an additional embodiment, the node data may further include PTN network information relating to how different PTNs relate to, or are connected to, each other. For example, the node data may be overlaid or appended with route data for each route of each mode of public transport. This data would be able to correlate a user's journey along a particular route with the appropriate mode of transport. This data may also be used to make future predictions about the next PTN that a user is expected to visit if they are indeed on that mode of transport. For example, if a user is waiting for a bus at a bus stop which is served by two different bus routes. Then, when the user moves off (at a speed consistent with bus travel) the TMDM 64 would be expected to arrive at one of two PTNs (bus stops), a first corresponding to the first route, and a second corresponding to the second route. When the user visits one of these PTNs, further weight can be added to the TMDM's decision that the user is in fact on a bus. Furthermore, if the user stops and then moves off on a route different to that which the bus is on, it may indicate that the mode of transport has changed.

In an alternative embodiment of the present invention, the user is permitted to input user preferences regarding defined locations that the user may regularly visit (user nodes), for example home, work, school, gym. The user may also include preferences regarding the mode of transport that is used when travelling between those locations. For example, the user may always drive between home and work, or home and school.

Of course, a user may alternate their methods of travelling, for example, driving to work one or two days a week and getting a bus the remainder of the time. Typically, when using two different modes of transport between defined locations, the user will travel via slightly different routes, i.e. when driving the user may take the shortest route, where the bus having a set route may travel further. Alternatively, the bus may follow a relatively direct shorter route, using bus lanes which speed up bus travel on congested roads, whereas when driving the user may travel longer to avoid congested routes. In one embodiment, the GUI permits the user to specify a mode for a particular route. For example, the user may specify for journeys leaving from HOME, and travelling to WORK, IF the route passes via location A, the user is driving, otherwise the user is on the bus. This is the present embodiment the mode of transport can be determined fairly reliably in this particular situation.

Another user preference which may be set relates to providing additional information that can identify work related travel from personal travel. For example, the user may specify days of the week, and times, during which travel is attributed to work, and travel outside these days and times is attributed to personal travel. This feature may, of course, be disabled during holiday periods. It is of course assumed that the device 2 has an internal clock and calendar in this regard.

It is envisaged that the device need not rely solely on location data provided by a location determining satellite system in determining the mode of transport. The user may manually enter map coordinates of journeys undertaken, though this can be more laborious for the user.

The statements of invention have set out several characteristics of the present invention and the present embodiments. It is to be considered for avoidance of any doubt that these features are also present in the embodiments described in detail in this section of this application.

In an alternative embodiment, the user is further permitted to selectably override the TMDM 64, such that the user sets their own travel mode. This may for example be preferable when the user is cycling or running, since this avoids the possibility of the wrong mode of transport being determined by the device. A further advantage of enabling this type of override is that a user can enter, via the GUI, their weight and obtain a reading at the end of their run or cycle for the number of calories burned.

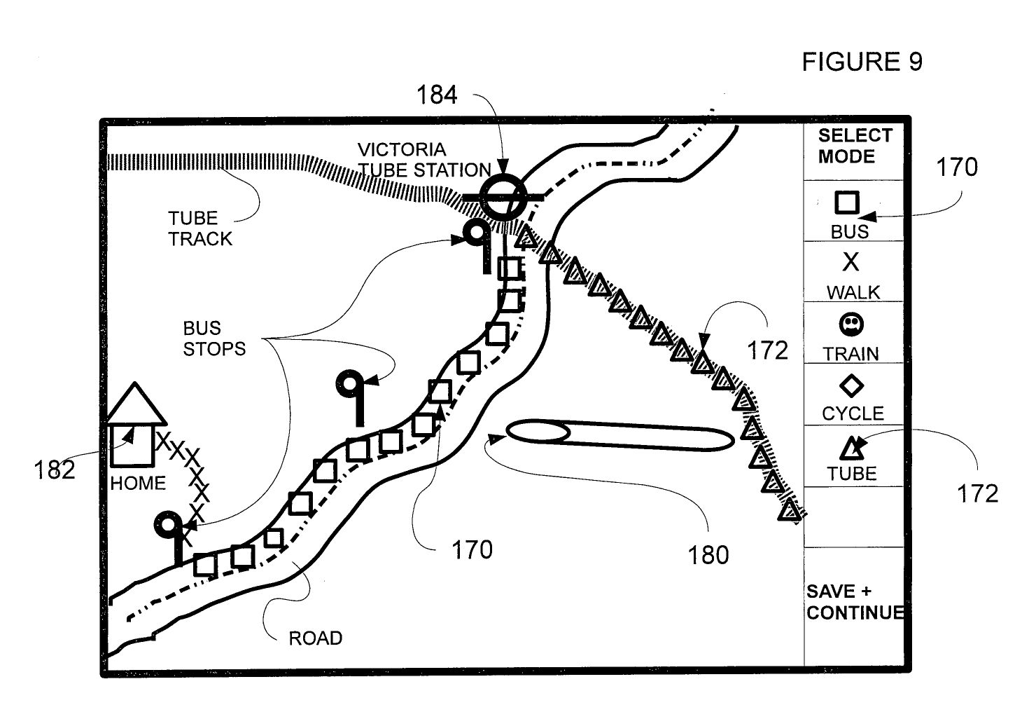

The above override selection may be entered through the GUI in a simple, hierarchal-menu driven system (not shown), by enabling the user to select the override function, and select the appropriate mode of transport through use of appropriate buttons. An alternative override function may be provided using a haptic interface, which uses a touch screen device. In this embodiment, the user may chose to review their movements for a given day, and will be shown their route in relation to a very simplistic map, as shown in FIG. 9. The very simplistic map provides enough information for the user to identify where they changed mode of transport but does not significantly add to the amount of memory required for this data. In one embodiment, the simplistic map may comprise details regarding the PTNs, i.e. names of each bus stop or train/tube station, in order to enable the user to identify when they changed modes of transport during their journey. In another embodiment, the vary simplistic map may be augmented with additional schematic data, for example, an indication of where major roads, and train lines are located, as demonstrated in FIG. 9.

An alternative embodiment may provide for life-like map images to be downloaded to the device from map image providers (e.g. Google Maps™). In this embodiment the PTN data may be overlaid on top of the map image and give the user a much more realistic view of their journey. However, it is to be appreciated, that this embodiment has greater device memory requirements that previously described embodiments.

The route shown may indicate different modes of transport for different legs of the journey, for example, squares 170 in FIG. 9 represent the user travelling on a bus, and triangles 172 represent the user travelling on a tube.

When reviewing this data, the haptic interface permits a user to correct changes in the mode determination if the user identifies that the device has made an error in its determination. The haptic interface enables the user to select portions of the journey and select the appropriate mode of transport from a list given. The selection of a portion of the journey, may include the user physically tracing along the route with a selection tool 180, or digit. Alternatively, the user may select (touch) the start, and end points of a journey leg and select (touch) the appropriate mode from those listed. In the example shown in FIG. 9, the user may select a home icon 182, and a tube station 184.

Other methods of overriding the TMDM 64 will be appreciated by the skilled person. For example, wireless communication (i.e. Bluetooth, infrared, and near field communication, e.g. RFID tags) technology may be used to indicate when the device is within a certain distance of a wireless or near field communication device. Examples of the ways in which these technologies may be used is summarised below.

If there are multiple users in close geographic proximity each using a portable device loaded with means for effecting the invention as described herein, then those devices can communicate with one another, for example using a wireless communication protocol such as Bluetooth or 802.11a/b/g/n, and share the details of modes of transport that they have determined. Users that have shared the same recent journey history are likely to have adopted similar modes of transport, be that sitting in adjacent cars in a traffic jam, or on the same bus or train, and the sharing of data can be used to improve the accuracy of the travel mode determination. The longer that the users are in proximity with one another, the more likely it is that they are sharing the same mode of transport.

A further way of increasing the accuracy of determining the mode of transport is to provide the portable device with an indication that a particular mode of transport is being used, rather than allowing the device to make possibly spurious best guess determinations. For example, a docking clip in a car or bicycle for holding the device of the embodiment, can include a communication element (such as an RFID chip) which can communicate with the device to inform it of the actual mode of transport being used.

An alternative method of improving the accuracy by which the TMDM 64 determines the mode of transport is through the use of additional sensor data inputs. For instance, it may be hard to distinguish between fast walking and cycling. If the user were to wear a heart-rate monitor, the increased heart-rate during the fast-walking period would be indicative of that mode of transport.

Alternatively, other sensors such as accelerometers attached to the user or the user's vehicle (e.g. car/bicycle) could be used as an additional source of data correction. For instance in urban areas cycling and driving may result in similar average speeds over fixed distances. However, a car is likely to accelerate differently to a bicycle. This could also help distinguish between walking and running and cycling.

Accelerometers are hardware devices that can detect the magnitude and direction of the acceleration of the device as a vector quantity. Accelerometres can also be used to sense inclination, vibration, and shock. They are increasingly present in portable electronic devices such as mobile phones as they are becoming popular in gaming applications.

However, it is to be appreciated that the acceleration of the device can also be determined by calculating changes in speed over time.

Taking acceleration and deceleration into account when determining different modes of transport also makes it possible to determine how a mechanised form of transport is driven, since this also has a bearing on carbon footprint calculations, and can enable more accurate carbon footprint calculations to be carried out by varying the multiplication factors (described below) accordingly.

The above realisation leads on to utilising very accurate data from engine control units (ECUs) which are found in cars for example regarding how they are driven, and the carbon produced as a result. Therefore, in another embodiment of the present invention, the TMCM of the portable device also make use of readings from ECUs in order to determine a most appropriate multiplication factor for carbon footprint determination.

As indicated in the preceding description, a driving force behind the need to accurately determine a user's mode of transport is to help calculate the user's environmental impact. Once the mode or modes of transport have been determined for a particular journey, or at least weightings made in respect of likely mode or modes adopted, it may also be possible to calculate the environmental impact of the journey using the carbon calculating module 68.

The device can be provided with preset parameters, either at creation or by a user “on-the-fly”, as to, e.g. the type of car, its fuel consumption, the average number of passengers carried, the number of bus/train passengers, etc., which can be applied in coming to a conclusion as to the user's environmental impact.

Furthermore, the device need not be a mobile phone. Another suitable device may include a key fob could be used, to monitor and store users movements, this could the dock with a personal computer of the user to perform calculations and provide feedback. Alternatively, a simple stand alone device could be used and could allow the user to make simple override selections, and still provide some quantity of feedback. Again, this stand alone device may dock with a personal computer to make more robust, more accurate calculations on the basis of the data recorded.

Data regarding a users movements may also be recorded on a bracelet device worn by the user, and being connectable to a personal computer of the user. Here data storage limitations are not a constraint and as such results of the users movements may be visually represented in relation to more detailed map images. Similarly, determinations regarding mode of transport may be carried out by the PC and may make use of more in depth node information, for example, road networks, and cycle networks.

In this embodiment, the PC may make use of a Geospatial Information System (GIS) also known as Geomatics. A GIS is a computer based system or tool which provides the facility to collect, store, manipulate, retrieve and analyse spatially-referenced data, i.e. node data. A popular well-known application of GIS is in vehicle navigation systems, where a visual representation of a map area relevant to the device's location is displayed and overlayed with additional information, for example, road networks in the form of nodes. In much the same way, it is possible to overlay PIN data, and to cross-check a user's location for nearby PTNs which are within a distance of X metres, where X is dependent on the mode of transport.

According to an alternative embodiment of the invention, the mobile device may not utilise the aforementioned method of determining the mode of transport, and may instead make use of a positioning system, including a node data database, and a haptic interface as described above. In this aspect, the device monitors the user's movements, and displays the route of the movement on the screen. The user is then able, through the haptic interface to selection portions of the journey (in the same manner as described above) and to set the mode of transport accordingly.

In a further additional embodiment this using the PTN network information it is possible to select alternative routes to a journey taken by a user in order to calculate an alternative carbon footprint to the one relating to the actual journey completed. For example, to compare rail or road travel to air travel. This may be achieved by the user selecting start and end points of their journey and device being arranged to determine a most direct route using alternative modes of transport.

Alternatively, this may be achieved through use of the network of PTNs which is stored in the database in the embodiment which makes use of the relationship between nodes to assist in the determination of the mode of transport.

Another example of using the above network of PTNs, and/or a database of train and road networks, is to permit the user to input details of a journey they would like to take, and to request information regarding which route they should take in order to minimise the effect on the environment. For example if a user wants to travel from one city to another, they may be able to fly directly. However, by querying a journey planning database the device can determine other possible routes, for example train routes, which would result in a lower carbon footprint. The journey planning database may be the network of PTNs (providing the relationship between nodes is known) or may include a database of all train routes, and bus routes for a given region. Alternatively, third party journey planning tools may be used via an communication channel for example, Internet, WiFi or GPRS.

It is to be appreciated that where reference as been made to specific examples of speed, CO₂ multiplication factors, and angles, that these numbers are exemplary only and other more suitable numbers may be used. For example, speeds of transport may vary from country to country.

An application for another aspect of the present invention may be in providing a tool that enables a user to track simply when they take flights, for the purpose of calculating their carbon footprint, or for determining the time spent and distance traveled when flying. This is a ‘lighter’ application and requires even less memory or processing power as it is only concerned with a single mode of transport.

In this embodiment, the method and system would still be required to monitor and log a user's movements. However, the method and system would be primarily be used to identify when the user was in the vicinity of an airport, and if a flight was taken. This is for simpler as the node data may only comprise details of all airports (throughout the world). Determination of whether a flight has taken place may be achieved my monitoring if the mobile phone has been turned of for a period of time, and turned on again within the vicinity of another airport, such that it was only possible for the user to have traveled from the first airport to the other, during that period, by flying.

As described above, other methods of determining if the user took a flight include: determining of speed of movement, altitude and/or acceleration are attributable to flying.

In this embodiment, the PTN node data may also include details of likely flight paths for journeys taken to further improve the accuracy of calculating a user's carbon footprint.

This embodiment offers the advantage that is very simplistic, requires the use of less processing and memory resources, and is an accurate way of determining the user's carbon footprint attributed to flying which is considered to be the mode of transport which is most damaging to the environment.

The present invention has been designed in such a way so as to minimise processing power and memory usage. This is a key advantage as it enables the invention to be used with portable devices where these resources are limited. The captured journey data set is also minimised, and this advantageously permits the computations to be effect very quickly via a user's home personal computer, which benefits from increased processing power. In addition, this small data set advantageously enables the processing of multiple users simultaneously using a central server.

1. A processor-implemented method of determining a mode of transport for a portion of a users journey, the method comprising:
receiving, at a portable device being carried by a user, position data for current locations of the user over a period of time;
determining, from the position data a characteristic of the speed for the journey portion;
identifying possible modes of transport on the basis of pre-established ranges of speed characteristics for particular modes of transport; and
selecting a most likely mode of transport from the identified possible modes of transport based on the proximity of the user's position data to known public transport nodes.

2. The processor-implemented method of claim 1, wherein the selecting step comprises:
querying a database of location data for known public transport nodes each having an associated proximity,
identifying any public transport nodes within the associated proximity of the user's position data; and
storing the identified nodes in a travel status log.

3. The processor-implemented method of claim 2, wherein the known public transport nodes are categorised by type of public transport, and the associated proximity of each node depends on the category of public transport associated with that node.

4. The processor-implemented method of claim 1, further comprising:
identifying event-related data from the received position data, the determined characteristic of speed, and/or the identified public transport nodes; the event-related data comprising a transport difference characteristic which can be used to distinguish between different modes of transport;
storing the event-related data; and
using the event-related data to modify the most likely mode of transport as determined from the results of the selecting step.

5. The processor-implemented method of claim 4, wherein the using step comprises using rules-based logic to eliminate certain possible modes of transport on the basis of the event-related data, wherein each logic rule defines a particular characteristic of one or more modes of transport.

6. The processor-implemented method of claim 4, wherein:
the event-related data is selected from the group comprising: individual journey legs, durations of position data signal loss, rate of change in direction of travel, and stationary moments; and
the using step comprises using the event-related data during the selecting step in order to assist in the accurate determination of the user's mode of transport for a current journey leg.

7. The processor-implemented method of claim 4, wherein:
the event-related data is selected from the group comprising: individual journey legs, durations of position data signal loss, rate of change in direction of travel, and stationary moments; and
the using step comprises using the event-related data to correct a previously determined mode of transport determined by the selecting step.

8. The processor-implemented method of claim 1, further comprising:
sensing an additional user device in the local vicinity of the user implementing the method of claim 1;
communicating with the additional user device to determine the additional user device's current selected mode of transport; and
correcting the user's selected mode of transport, if the position data for both the user and the additional user correlate with each other for a required time period, there is a difference between the selected modes of transport for the user and the additional user, and if the selected mode of transport established for the additional user, is deemed to be more reliable than the selected mode of transport for the user.

9. The processor-implemented method of claim 1, further comprising:
receiving additional sensor data; and
using the additional sensor data during the selecting step in order to enable more accurate determination of the user's mode of transport for a journey leg.

10. The processor-implemented method of claim 1, further comprising:
receiving additional sensor data; and
using the additional sensor data to correct a previously determined mode of transport determined by the selecting step.

11. The processor-implemented method of claim 9, wherein the additional sensor data is data provided by a device selected from one of the group comprising: a heart rate monitor, an accelerometer, wireless communication device, and a near field communications device.

12. The processor-implemented method of claim 1, further comprising identifying altitude and/or direction data, wherein the selecting step utilises the identified altitude and/or direction data.

13. The processor-implemented method of claim 9, wherein the using step comprises using rules-based logic to eliminate certain possible modes of transport on the basis of the additional sensor data or the direction/altitude data.

14. The processor-implemented method of claim 1, wherein the receiving step comprises receiving location data derived from received satellite positioning data or received mobile telecommunication triangulation positioning data.

15. The processor-implemented method of claim 1, further comprising:
presenting the determined mode of transport for a portion of the user's journey, and
enabling the user to input a different mode of transport to override the selection if the portion of the user's journey has been incorrectly determined.

16. The processor-implemented method of claim 15, wherein the presenting step is implemented on a display and the enabling step is effected through a haptic interface.

17. The method of claim 1, further comprising receiving user input data, via a graphical user interface of the portable device, wherein the user input data comprises personal user locations frequently visited by the user; and
using the personal user locations during the selecting step in order to enable more accurate determination of the user's mode of transport for a journey leg.

18. The processor-implemented method of claim 1, comprising
receiving user preference data, via the graphical user interface, the user preference data detailing features of a typical user journey: and
using the user preference data during the selecting step in order to enable more accurate determination of the user's mode of transport for a journey leg.

19. The processor-implemented method of claim 1, comprising:
specifying relationships between public transport nodes, the relationships being specified for nodes which are linked by a common mode of public transport having a route for that mode of transport connecting the nodes; and
using the specified relationships during the selecting step in order to enable more accurate determination of the user's mode of transport for a journey leg.

20. The processor-implemented method of, further comprising:
querying a database of location data for known public transport nodes each having an associated proximity;
identifying any public transport nodes within the associated proximity of the user's position data;
storing the identified nodes in a travel status log;
predicting one or more likely next public transport nodes the user will be within the proximity of if the determined mode of transport is correct;
checking that an actual next identified public transport node is one of the one or more expected public transport nodes in order to verify a determined mode of transport is correct; and
correcting the determined mode of transport, if the next identified public transport node is not one of the one or more expected public transport nodes.

21. A processor implemented method of determining a carbon footprint of a user, the method comprising:
a method of determining a mode of transport for a portion of a user's journey according to any preceding claim;
calculating the environmental impact of each leg of the journey for each different type of mode of transport; and
presenting the results of the calculating step to the user.

22. The processor-implemented method of claim 21, wherein the presenting step comprises presenting the results graphically on a screen of the portable device.

23. The processor-implemented method of claim 21, wherein the presenting step comprises presenting the results in one of a plurality of different user-selected units, at least one of the plurality of different units being in a readily comprehendible unit of an everyday object, for example volume being expressed in the size of a bus.

24. The processor-implemented method of claim 21, further comprising finding an alternative route for a user journey which results in a lower overall environmental impact.

25. An apparatus for determining a mode of transport for a portion of a user's journey, the apparatus comprising:
a portable device being carried by a user, the device incorporating receiving means for receiving position data for current locations of the user over a period of time;
a determining module arranged to determine from the position data, a characteristic of the speed for the journey portion;
an identifying module arranged to identify possible modes of transport on the basis of pre-established ranges of speed characteristics for particular modes of transport; and
a selecting module arranged to select a most likely mode of transport from the identified possible modes of transport based on the proximity of the user's position data to known public transport nodes.

26. The apparatus of claim 25, wherein the determining module, identifying module and selecting module are also provided within the portable device.

27. The apparatus of claim 25, wherein the apparatus comprises a mobile telecommunications device.

28. The apparatus of claim 25, further comprising means for determining the environmental impact of the portion of the journey, and means for displaying the environmental impact to the user.

29. A processor-implemented method of recording a user's air travel, the method comprising:
receiving, at a portable device being carried by a user, position data for current locations of the user over a period of time;
identifying, from the position data, whether the user is in the vicinity of an airport;
determining when a flight takes place;
inferring a measure for the distance of that flight; and
storing the determined distances of all of the flights the user takes in a travel status log.

30. The processor-implemented method of claim 29, wherein the determining step comprises:
monitoring whether the portable device is switched off in the vicinity of a first airport, and is subsequently turned on in the vicinity of a second airport;
calculating the speed at which the user traveled between the first and second airports; and
confirming the user traveled via an aircraft when the calculated speed is only possible via an aircraft.

31. The processor-implemented method of claim 30, wherein the inferring step comprises calculating a direct distance value for the distance between the first and second airports or using a route specific distance value retrieved from an air travel route database, the route specific distance value being attributed to a realistic flight plan for specific routes.
